(19) United States
(12) Patent Application Publication
(10) Pub. No.: US 2006/0236894 A1
(43) Pub. Date: Oct. 26, 2006

(54) Use of tio2 residues from a sulfate method

(76) Inventor: Djamschid Amirzadeh-Asl, Moers (DE)

Correspondence Address: FULBRIGHT & JAWORSKI, LLP, 666 FIFTH AVE, NEW YORK, NY, 10103-3198, US

(21) Appl. No.: 10/566,595

(22) PCT Filed: Aug. 6, 2004
(86) PCT No.: PCT/EP04/08837

§ 371 Date: Jun. 12, 2006

(30) Foreign Application Priority Data
Aug. 9, 2003 (DE) 10336650.4

(51) Int. Cl. C09C 1/02

(52) U.S. Cl. 106/471

(57) ABSTRACT

The invention relates to the use of TiO₂ residues from a sulfate method used in metallurgical processes or as a component of fireproof materials. According to the invention, the TiO₂ residues are dried and added without further mixing with other substances.

The invention relates to the use of TiO₂ residues from the sulfate process.

The use of residues from TiO₂ production (TiO₂ residues) in the metallurgical industry is known in principle. For example, DE 4419816 C1 describes a titanium-containing additive comprising TiO₂ residues and further substances. DE 19705996 C2 describes a process for the production of an additive comprising TiO₂. In that process, a mixture of TiO₂ residues and iron or iron compounds is subjected to heat treatment at from 200 to 1300° C. The laborious metering and mixing of the TiO₂ residues with the further constituents of the additive are disadvantageous.

DE 19830102 C1 describes the use of a fine-grained TiO₂-containing residual substance formed in the production of TiO₂ by the chloride process. A disadvantage of this teaching is that such fine-grained TiO₂-containing residual substances are not formed in the production of TiO₂ by the sulfate process and the teaching is therefore not applicable to TiO₂ residues from the sulfate process.

The object of the invention is to overcome the disadvantages of the prior art and, in particular, to indicate a simple use of TiO₂ residues from the production of TiO₂ by the sulfate process.

The object is achieved by the use of TiO₂ residues from the sulfate process in metallurgical processes or as a constituent of refractory materials, the TiO₂ residues being subjected to heat treatment and used without being mixed further with other substances.

Surprisingly, it has been found that, in metallurgical processes or as a constituent of refractory materials, the TiO₂ residues from the sulfate process develop, per se, the same desired action as the mixtures of TiO₂ residues and other substances provided hitherto. The TiO₂ residues can be used in the heat treatment in the unwashed state or in the washed and neutralised state.

The heat treatment of the TiO₂ residues is preferably carried out at from 100 to 1300° C. The TiO₂ residues can be in powder form or in the form of moulded bodies (obtained, for example, by sintering, pelletisation, briquetting or compression).

The heat-treated (dried) TiO₂ residues preferably comprise the following substances as the main constituent (amounts are in wt. %):

| | |
|---|---|
| TiO₂ | from 35 to 70 |
| SiO₂ | from 5 to 40 |
| Iron compounds | from 2 to 15 |
| MgO | from 1 to 15 |
| CaO | from 0.5 to 15 |

Alternatively, the heat-treated (dried) TiO₂ residues can comprise the following main constituents, calculated as oxides (amounts are in wt. %):

| | |
|---|---|
| TiO₂ | from 20 to 80 |
| SiO₂ | from 2 to 30 |
| Al₂O₃ | from 0 to 15 |
| Fe₂O₃ | from 0 to 15 |
| MgO | from 1 to 15 |
| CaO | from 0 to 15. |

In a preferred use, the heat-treated TiO₂ residues are injected into a metallurgical furnace, fox example a blast furnace or electrosmelting furnace or cupola. This results in an increase in the durability of the refractory furnace lining. The TiO₂ residues are further used in tap hole masses and other refractory materials.

The subject-matter of the invention is explained in greater detail by means of the following example.

### EXAMPLE 1

### Working-Up of a TiO₂ Residue from the Sulfate Process for Use in a Metallurgical Furnace

100 t of pressure filter discharge (digestion residue), which formed during digestion in the production of TiO₂ by the sulfate process and had a solids content of 75 wt. % with a TiO₂ content of 53 wt. % (based on the solids content), were treated in a rotary furnace at an inlet temperature of 650° C. The finely divided product which was obtained had a residual moisture content of 0.5 wt. %. The product exhibited very good pourability and could very readily be injected into a metallurgical furnace (in this case a blast furnace) by means of pneumatic feeding.

The product had the following composition (in wt. %):

| | |
|---|---|
| TiO₂ | 53 |
| Fe₂O₃ | 5.9 |
| SiO₂ | 27.8 |
| Al₂O₃ | 6.1 |
| MgO | 2.4 |
| CaO | 4.2 |

| | |
|---|---|
| TiO₂ | from 35 to 70 |
| SiO₂ | from 5 to 40 |
| Iron compounds | from 2 to 15 |
| MgO | from 1 to 15 |
| CaO | from 0.5 to 15. |

| | |
|---|---|
| TiO₂ | from 20 to 80 |
| SiO₂ | from 2 to 30 |
| Al₂O₃ | frcm 0 to 15 |
| Fe₂O₃ | from 0 to 15 |
| MgO | from 1 to 15 |
| CaO | from 0 to 15. |

1-7. (canceled)

8. A method comprising subjecting a TiO₂ residue from a sulfate process to heat treatment and, without being mixed further with other substances, performing a metallurgical process or preparing a refractory material with the heat treated TiO₂ residue.

9. The method according to claim 8, wherein the TiO₂ residues are subjected to heat treatment at from 100 to 1300° C.

10. The method according to claim 8, wherein the TiO₂ residues are in powder form or in the form of molded bodies.

11. The method according to claim 9, wherein the TiO₂ residues are in powder form or in the form of molded bodies.

12. The method of claim 8, wherein the TiO₂ residue comprises from 35 to 70 wt. % TiO₂; from 5 to 40 wt.% SiO₂; from 2 to 15 wt.% of iron compounds; from 1 to 15 wt.% MgO; and from 0.5 to 15 wt.% CaO.

13. The method of claim 8, wherein TiO₂ residue comprises calculated as oxides from 20 to 80 wt.% TiO₂; from 2 to 30 wt.% SiO₂; from 0 to 15 wt.% A₁2O₃; from 0 to 15 wt.% Fe₂O₃; from 1 to 15 wt.% MgO; from 0 to 15 wt.% CaO.

14. The method according to claim 8, wherein the dried TiO₂ residues are injected into a metallurgical furnace.

15. The method according to claim 8, wherein the dried TiO₂ residues are used in a tap hole mass.

16. The method of claim 9, wherein the TiO₂ residue comprises from 35 to 70 wt.% TiO₂; from 5 to 40 wt.% SiO₂; from 2 to 15 wt.% CaO.

17. The method of claim 10, wherein the TiO₂ residue comprises from 35 to 70 wt.% TiO₂; from 5 to 40 wt.% SiO₂; from 2 to 15 wt.% of iron compounds; from 1 to 15 wt.% MgO; and from 0.5 to 15 wt.% CaO.

18. The method of claim 11, wherein the TiO₂ residue comprises from 35 to 70 wt.% TiO₂; from 5 to 40 wt.% SiO₂; from 2 to 15 wt.% of iron compounds; from 1 to 15 wt.% MgO; and from 0.5 to 15 wt.% CaO.

19. The method of claim 9, wherein TiO₂ residue comprises, calculated as oxides, from 20 to 80 wt.% TiO₂; from 2 to 30 wt.% SiO₂; from 0 to 15 wt.% A₁2O₃; from 0 to 15 wt.% Fe₂O₃; from 1 to 15 wt.% MgO; from 0 to 15 wt.% CaO.

20. The method of claim 10, wherein TiO₂ residue comprises; calculated as oxides, from 20 to 80 wt.% TiO₂; from 2 to 30 wt.% SiO₂; from 0 to 15 wt.% A₁2O₃; from 0 to 15 wt.% FeO₃; from 1 to 15 wt.% MgO; from 0 to 15 wt.% CaO.

21. The method of claim 11, wherein TiO₂ residue comprises, calculated as oxides, from 20 to 80 wt.% TiO₂; from 2 to 30 wt.% SiO₂; from 0 to 15 wt.% A₁2O₃; from 0 to 15 wt.% Fe₂O₃; from 1 to 15 wt.% CaO.

22. The method of claim 12, wherein TiO₂ residue comprises, calculated as oxides, from 20 to 80 wt.% TiO₂; from 2 to 30 wt.% SiO₂; from 0 to 15 wt.% A₁2O₃; from 0 to 15 wt.% Fe₂O₃; from 1 to 15 wt.% MgO; from 0 to 15 wt.% CaO.

23. The method according to claim 9, wherein the dried TiO₂ residues are injected into a metallurgical furnace.

24. The method according to claim 10, wherein the dried TiO₂ residues are injected into a metallurgical furnace.

25. The method according to claim 11, wherein the dried TiO₂ residues are injected into metallurgical furnace.

26. The method according to claim 12, wherein the dried TiO₂ residues are injected into a metallurgical furnace.

27. The method according to claim 13, wherein the dried TiO₂ residues are injected into metallurgical furnace.

28. The method according to claim 14, wherein the dried TiO₂ residues are injected into a metallurgical furnace.

29. The method according to claim 15, wherein the dried TiO₂ residues are injected into a metallurgical furnace.

30. The method of claim 8, wherein a metallurgical process is performed.

31. The method of claim 8, wherein a refractory material is prepared.
